(19) United States
(12) Patent Application Publication
(10) Pub. No.: US 2001/0027581 A1
(43) Pub. Date: Oct. 11, 2001

(54) Dyeable and stain resistant nylon carpet treatment

(76) Inventor: Yanhui Sun, Wilmington, DE (US)

Correspondence Address: E I DU PONT DE NEMOURS AND COMPANY, LEGAL DEPARTMENT - PATENTS, 1007 MARKET STREET, WILMINGTON, DE, 19898, US

(21) Appl. No.: 09/757,001

(22) Filed: Jan. 9, 2001

Related U.S. Application Data
(63) Continuation-in-part of application No. 09/522,493, filed on Mar. 10, 2000.

(51) Int. Cl. C09B 67/00

(52) U.S. Cl. 8/512; 8/509

(57) ABSTRACT

This invention relates to a process for increasing the stain resistance of an acid dyeable nylon filament or staple fiber, especially in the form of a textile or floor covering article such as a carpet. The invention involves the addition of a stain blocker to the dye bath through which the textile article is passed. The stain blocker contains phenolic groups and is free of sulfonic and carboxylic groups. After the dyeing process, the carpet is subjected to sequential heat treatments.

### FIELD OF THE INVENTION

The invention relates to dyeing a textile article, and more particularly concerns a method for treating a textile article made from dyeable nylon filament or staple fiber yarns with a stain blocker composition during the dyeing process.

### BACKGROUND OF THE INVENTION

The following disclosures may be relevant to various aspects of the present invention and may be briefly summarized as follows:

U.S. Pat. No. 5,145,487 to Hangey et al. discloses improved methods and compositions to enhance stain resistance of carpet fiber. In this disclosure sulfonated aromatic condensates (s.a.c.) are used to enhance the stain resistance of the carpet fabric. The s.a.c. can be combined with fluorocarbon compounds for soil resistance, thiocyanates, and/or salts having divalent cations, such as magnesium sulfate to enhance stain resistance.

U.S. Pat. No. 4,619,853 to Blyth et al. discloses carpets having a primary backing and a pile consisting essentially of polyamide fibers stitched into the primary backing. The fibers are characterized as being stain resistant and the backing is characterized as being impervious to water. The carpet is easy to maintain since its fibers are stain resistant and water can be used to clean the carpet without fear of the water penetrating the backing and being absorbed by the padding. The fibers are rendered stain resistant by treating the fibers, either before or after tufting, with an effective amount of a sulfonated phenol-formaldehyde or napthol-formaldehyde condensation product. By sulfonated phenol-formaldehyde and napthol-formaldehyde condensation product is meant that the product contains sulfonic acid groups or a salt thereof attached to carbon atoms of the phenolic or naphtholic groups.

U.S. Pat. No. 4,501,591 to Ucci et al. discloses an improvement in certain processes for continuously dyeing polyamide carpets whereby stain resistance is imparted to the carpets during the dyeing process. The improvement involves adding an alkali metal silicate (e.g. sodium meta silicate) and a sulfonated phenol-formaldehyde condensation product to the dye liquor used in the dyeing process. If either the silicate or condensation product is omitted from the liquor, the improvement is not achieved.

U.S. Pat. No. 4,147,512 to Kobayashi et al. discloses a fixing agent for improving the fastness properties of dyeings on polyamide fibers being a new condensation product of 4,4′-dihydroxydiphenylsulfone, 4,4′-dihydroxydiphenylsulfonesulfonic acid and a lower aliphatic aldehyde, which has a mean molecular weight of about 5,000 to about 30,000 and a ratio of carbon atom content and sulfur atom content of 3.0:1 to 4.8:1, or its metal salt, and when polyamide fibers are treated with the condensation product or its metal salt, or the condensation product in the presence of a salt of metal, at a temperature of 950 to 120° C., the fastness properties, especially wet-fastness properties of dyeings on polyamide fibers are remarkably improved. The sulfonated fixing agent is added to the dye bath of a nylon article to improve the fastness of the dyeing.

Dyeable nylon carpet is normally made more stain resistant by the use of stain blockers topically applied to the carpet after the carpet has been dyed. Such stain blockers work by forming a negative charge which repels acid dyes having a similar negative charge. This occurs because the stain blockers contain either sulfonic or carboxylic groups which, in the presence of water, dissociate to form the negative charges which remain on the surface of the nylon fiber. The negative charge functions act as a barrier to prevent acid dyes from diffusing into the carpet fiber.

A carpet treatment known as StainMaster®, a registered trademark of E. I. DuPont de Nemours and Company, Wilmington, Del., uses a topical application such as spraying to apply stain blocker greater than 0.6% by weight of fiber to the carpet fiber. This stain blocker contains sulfonate and/or carboxylic groups. The stain resistance provided by this treatment has been found to decrease after washing and exposure to traffic. For example, the stain resistance has been found to begin to decrease after 300,000 foot-traffics and two cleanings.

A more durably stain resistant textile article, for example carpet made from white, acid dyeable nylon fiber would be desirable. This is particularly true for carpets in demanding, high-traffic areas such as hotels, restaurants, hospitals and airports. Preferably, this carpet would still be dyed using conventional dyeing equipment.

### SUMMARY OF THE INVENTION

Briefly stated, and in accordance with one aspect of the present invention, there is provided an improved process for dyeing a textile article containing nylon fiber comprising: passing the textile article through a boiling dye bath containing an effective amount of a stain blocker, wherein the stain blocker comprises phenolic groups and is free of sulfonic groups and carboxylic groups; rinsing the textile article after passing the textile article through the boiling dye bath; and drying the textile article after rinsing.

Pursuant to another aspect of the present invention, a textile article comprising nylon fiber, dyeable by acid dyes, having thereon an effective amount of a stain blocker for stain resistance, wherein the stain blocker contains phenolic groups and is free of sulfonic groups and carboxylic groups.

### BRIEF DESCRIPTION OF THE DRAWINGS

The invention will be more fully understood from the following detailed description, taken in connection with the accompanying drawing, in which:

FIG. 1 is a perspective view of a textile article in accordance with the present invention.

### DETAILED DESCRIPTION OF THE INVENTION

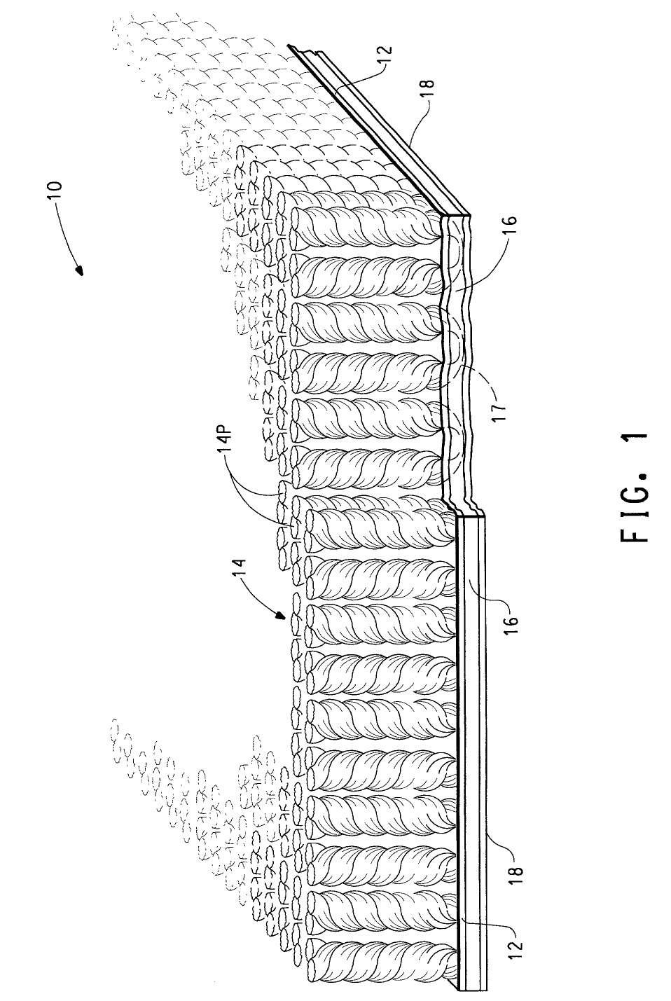

Referring now to the drawing, where the showing is for the purpose of describing an embodiment of the invention and not for limiting same. A textile article such as a floor covering article illustrated in FIG. 1 will be briefly described. A floor covering article is generally indicated in FIG. 1 by reference numeral 10. It is noted that the present invention is applicable to not only a floor covering article such as carpets and rugs, but any textile article of nylon fiber or similar fiber. The floor covering article 10 comprises a primary backing 12, through which pile yarn 14P is tufted therethrough. The pile yarns 14P extend upward from one side of the primary backing 12, forming a pile surface 14. A latex backing (e.g. coating or layer) 16 is applied to the opposite side of the primary backing 12 surface through which the pile yarn 14P extends. The latex backing 16 is applied by a roller or other conventional method to the back of the primary backing where the tufts 17 are present. The application of the latex backing 16 binds the individual filaments together and locks the tufts 17 in place preventing them from coming out of the carpet. The latex backing 16 also acts as an adhesive for a seondary backing 18 applied thereto. The secondary backing 18 adds stiffness and covers the tufts 17 of the floor covering article 10 made in this manner.

In the production of a textile article in which the article's fibers are white, acid dyeable nylon fibers, a process is described herein for treating the article with a stain blocker and dyeing the article with acid dyes, thereby rendering the article stain resistant. The stain resistant article is also described. Preferably, the textile article is a carpet.

Preferably, the carpet fiber is a white, acid dyeable fiber made from nylon homopolymer or nylon/polyester/dimethyl 5-sulfoisophthalate copolymer. This copolymer contains sulfonate (herein also referred to as SO₃) which is known to increase stain resistance in nylon fiber.

The carpet, in an embodiment of the invention, has an effective amount of stain blocker present on the carpet fiber to provide stain resistance. In the present invention, the stain blocker contains phenolic groups and is free of sulfonic groups (—SO₃) and carboxylic groups (—COOH). Phenolic, sulfonic and carboxylic groups are types of organic functional groups. By “free of” is meant that there are no measurable sulfonic and no measurable carboxylic groups in the polymer of the stain blocker. Preferably, this effective amount of stain blocker is between about 0.2% and about 2% by weight of fiber. The present invention is applicable to both batch and continuous process applications.

In an embodiment of the present invention, an acid dyeable textile article such as a carpet is passed through a boiling dye bath containing acid dyestuffs and a stain blocker. The stain blocker, as mentioned above, contains phenolic groups and is free of sulfonic and carboxylic groups. The stain blocker of the present invention is added to the dye bath and stirred or agitated as is customary in a dyeing process. The dye bath preferably contains between about 0.2% to about 2.0% by weight of the stain blocker, and most preferably between about 0.2% to about 0.5% by weight. In a typical dyeing process, the stain blocker is added after dyeing because of the sulfonic or carboxylic groups detrimental effect on the dyeing process described above. The present invention eliminates this detrimental effect and reduces the number of steps in the process by adding the stain blocker to the dye bath. Thus, the present invention adds efficiency and reduces the cost of the process. Upon exit from the dye bath the textile article is rinsed (e.g. with water) to remove excess dye and then dried.

In a preferred embodiment of the invention, before passing the textile article through the dye bath, the undyed textile article is scoured or washed to remove any finish oils that may be remaining on the fibers of the textile article after fiber manufacturing. As shown in Table 1.1, a carpet that has been scoured has a higher stain resistance than that which has not been scoured.

The acid dyestuffs used for the dye bath may be any acid dyestuffs conventionally used to dye nylon fiber. An effective amount of the desired dyestuffs is dissolved in water at an elevated temperature (70-100 degrees C), and the dye solution is added to the dye bath. The effective amount is the amount of dye required to achieve the desired color match. An example of dye concentrations for the color of light gray is shown in Table 1.2. The carpet is allowed to remain in the boiling dye bath containing a phenolic oligomer (e.g. Zelan® 8236) and acid dyestuffs for preferably 30 to 45 minutes. (Longer or shorter lengths of time for the carpet in the boiling dye bath are believed not to cause a detrimental effect.) The carpet is then removed from the dye bath, rinsed and allowed to dry in a drying oven of at least 80 degrees C. The drying step is preferably carried out at 130 degrees C or greater temperature for between about 2 and about 10 minutes. A latex backing may then be applied, after which the carpet is heated again in an oven to at least 130 degrees C until the latex backing is cured, preferably for between about 5 and about 10 minutes. In a preferred embodiment, the carpet is further heat treated at 125 degrees C or greater for at least 5 minutes to increase stain resistance. Heating after the latex backing is cured is optional. However, it has been observed (see Table 2) that having multiple sequential heated steps increases the resulting stain resistance of the carpet. But, the number of multiple sequential heated steps should not reach or exceed the point where polymer degradation and yellowing of the latex backing occurs.

A stain blocker that is a phenolic oligomer or substituted phenolic oligomer, e.g. phenolic groups free of sulfonic groups and carboxylic groups, is required for use in the present invention. Zelan® 8236 (herein also referred to as “Zelan®”) is an example of such a phenolic stain blocker. Zelan® is provided by E. I. DuPont de Nemours and Company, Wilmington, Delaware. Zelan® is commercially available as a coffee stain resist on carpet. In this commercially available use as a coffee stain resist on carpet, it is applied topically by spraying it onto a carpet after the carpet has been dyed. Reference is made to U.S. Pat. No. 5,447,755, which is herein incorporated by reference, for disclosure of Zelan® preparation.

The structure of Zelan® 8236 is as follows:

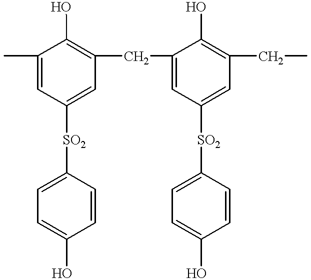

It is a condensation product from bisphenol-S (4,4′-sulfonyldiphenol) and formaldehyde.

It is also believed that the copolymer with bisphenol A (4,4′-isopropylidene diphenol)

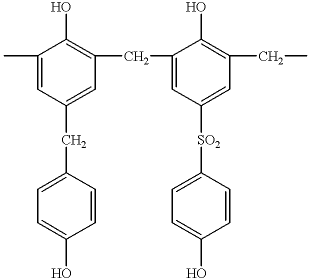

and the copolymer with cresol (methyl phenol):

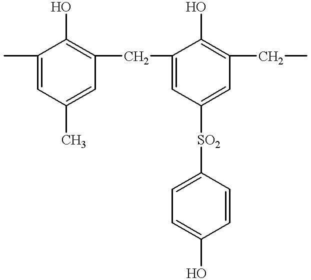

are also examples of phenolic oligomers for use in the present invention.

The phenolic oligomer is believed to diffuse into the amorphous region of a nylon fiber during dyeing, due to its known characteristic of having a high affinity for nylon polymer. As a result, the amorphous region of the nylon fiber is rendered unreceptive to acid dyes, including acid stains. It is further believed that the phenolic oligomer, as used in the present invention, coats the nylon fiber so that dyes may not reach the nylon dye sites as easily as without the phenolic oligomer. Regardless of the mechanism, the phenolic oligomer, when added to the dye bath, has been found to increase the stain resistance of nylon carpet.

In a preferred embodiment of the invention, a detergent is added to the dye bath, such as Softcide®, available from Stahmer Weston Scientific, Portsmouth, NH. The presence of a small amount of detergent, up to about 0.5 weight % of the fiber, in the dye bath has been found to increase the stain resistance of the carpet. The preferred amount of detergent in the dye bath is from 0.001 to 0.130 weight % per fiber.

The pH of the dye bath is adjusted, preferably by a sulfamic acid solution such as Auto-acid 10, available from Peach State Lab, Rome, Georgia, to between 3 and 5, and more preferably between 4 and 5. The need for pH adjustment is because the phenolic resin of the stain blocker in the present invention is not soluble in low pH water such as pH 3. Thus, the dyeing process is begun at a higher pH such as 6. To further illustrate, the following two scenarios are provided: 1) The phenolic resin, such as Zelan®, is added to the dye bath before boiling of the dye bath solution for about 40 minutes. Then, preferably a sulfamic acid solution such as Auto-Acid 10 is used to lower the pH down to between 3-5 after about 40 minutes of boiling. 2) The phenolic resin is added after about 30 minutes of boiling of the dye bath. Preferably a sulfamic acid solution is added after an additional 10 minutes (i.e. about 40 minutes in total) boiling time. By then, the phenolic resin has diffused into nylon fiber, so the addition of Auto-Acid 10 will not precipitate the phenolic resin out. The Zelan® solubility is, however reduced due to the pH change. The reduction in solubility is a driver to push the residue Zelan® in the dye bath solution onto nylon fiber. As a result, a higher Zelan® exhaust and better stain resistance is achieved at lower pH at the end of the dyeing process.

Optionally, a wetter (e.g. ranging from 0.05 to 0.3 weight percent on fiber), such as dioctoyl sodium succinate, is added to the dye bath. The wetter makes the fibers more accessible to the stain blocker by reducing the fiber surface tension. The dye bath may also optionally have a buffer (ranging from 0.1 to 1.0 weight percent on fiber) added therein to keep the pH of the dye bath constant. For example, the buffer may be monosodium phosphate or MSP, available from Fisher Scientific, Pittsburgh, Pennsylvania.

The addition of stain blocker, in the present invention, to the dye bath has minimal, if any, negative impact on the dyeing process, i.e., it does not prolong the dyeing cycle nor change the dye rate, depth or coloration.

### Test Methods

Kool-Aid Stain Rating

The following test procedure was used to determine the stain-resist performance of textile articles of sock and carpet samples.

20 ml of 9% Kool-Aid solution (Cherry flavored, sweetened with sugar) was poured onto a 4 inch by 6 inch carpet or sock sample by pouring into an approximately two inch diameter cylinder that was placed on the surface of the sample. The solution was allowed to absorb into the sample after which the cylinder was removed. After 24 hours, the sample was rinsed with a large amount of cool tap water and centrifuged. The sample was allowed to air dry. The stain resistance rating of the sample was determined visually according to the color left on the stained area of the sample. The rating was determined by comparison with a series of ten transparent plastic rectangles in accordance with the AATCC (American Association of Textile Chemists and Colorists) Red 40 Stain Scale, in which 10 represents no staining, 9 very light staining, with increasing color as the scale decreases to 1, which represents heavy staining.

Relative Viscosity (RV)

A sample of yarn made from polymer is dried at 80 degrees C for 2 hours in a vacuum oven under nitrogen purge. The polymer is dissolved in a 90% formic acid solvent to a concentration of 8.4 weight % of nylon in solution. The relative viscosity is measured at 25 degrees C using a Viscotech forced flow viscometer model Y-900 and accompanying software model V5.6.1.1. Zytel® 101 is used as the polymer standard.

SO₃ (Sulfonate)

Using a hot plate, about 10 grams of nylon yarn is pressed into a circular mold to form a disk with a smooth flat surface. The disk is loaded into the x-ray spectrometer, Philips PW 1600, which is available from Royal Philips Electronics, Amsterdam, The Netherlands. The disk is irradiated with x-ray radiation, thereby exciting the disk to emit fluorescent x-rays. The wavelengths of the emitted x-rays characterize the elements present in the disk. The sulfur content is determined by measuring the intensity of the fluorescent x-rays associated with the wavelength characteristic of sulfur.

### EXAMPLES

I. Sock samples

Four different knitted sock samples were made from four different bulked continuous filament nylon yarns. Table 1 shows the compositions of these yarns, and the relative viscosity (formic acid based) and the sulfonate (S0₃) content (measured in eq/10⁶ grams) of each of the yarns.

TABLE 1
Yarn Compositions and Properties

| Example | Composition | RV | SO₃ |
|---|---|---|---|
| 1 | Nylon 6,6 homopolymer | 59.25 | 1.2 |
| 2 | Nylon 6,6 & 5% PET/dimethyl 5-sulfoiso- | 57.57 | 13.0 |
| | phthalate | | |
| 3 | Nylon 6,6 & 10% PET/dimethyl 5-sulfoiso- | 51.24 | 38.3 |
| | phthalate | | |
| Control | Nylon 6,6 homopolymer | 59.25 | 1.2 |

A Superba heat setting machine (manufactured by American Superba, Inc., Dalton, Georgia) was used on the yarns of Table 1. The sock samples were scoured to remove finish oils. The samples were scoured by adding them to an aqueous bath, containing 1% Merpol LFH (available from E. I. Du Pont de Nemours and Company, Wilmington, Del.) and 0.5% trisodium phosphate, at 110 degrees F (43.3° C.). After adding the sock samples to the aqueous bath, the temperature was raised to 160 degrees F (71.1° C.), and the samples were rotated for 20 minutes. The samples were then removed from the bath and rinsed with tap water. Table 1.1 shows the results of Example 1 described in Table 1 above. Scouring of the sample increased the Kool-Aid stain rating over the non-scoured sample. The Example in Table 1.1 had 0.2% Zelan® added to the boiling dye bath after 30 minutes of boiling similar to column III process of Table 4 below.

TABLE 1.1
Scoured vs. Nonscoured

Stain rating

| Sample | Not Scoured | Scoured |
|---|---|---|
| Example 1 | 5-6 | 8-9 |

0.2% Zelan® by weight of fiber was mixed with the aqueous dye bath solution. The dye bath also contained the following dyes at the following concentrations:

TABLE 1.2
Dyestuffs for Light Gray

| Dye | Concentration |
|---|---|
| Tectilon Blue 4RS-200% | 0.006% |
| Tectilon Yellow 3R-200% | 0.006% |
| Tectilon Red 2B-200% | 0.0042% |

This combination of dyes resulted in the color light gray. These dyes are available from Ciba Specialty Chemicals, Incorporated, Basel, Switzerland.

The dye bath was stirred to mix the dyestuffs and the Zelan®. The sock samples were dyed by placing the samples in the dye bath at 100 degrees C for 30 minutes, and then the pH was adjusted to about 4 using Auto-acid 10. The dye solution was maintained at the boiling temperature for 10 minutes. The samples were then removed from the dye bath, rinsed and dried at 130 degrees C. The samples were tested for stain resistance using the Kool-Aid stain rating scale. Table 2 shows the results of the Kool-Aid Test for the socks as-dyed as well as after further heat treatment. Table 2 shows the results of different dyed sock samples subjected to different dry heat temperatures of 160 degrees C, 170 degrees C, and 180 degrees C, for 5 minutes at each temperature.

A control sock sample was passed through the same process as described above with the exception that the addition of Zelan® to the dye bath was eliminated. The Kool-Aid Stain Test was similarly applied to this control sock sample. The results are shown in Table 2 as the “Control” example.

Table 2 shows that the addition of Zelan® in into the dye bath significantly increases the stain resistance. Furthermore, Table 2 shows that additional heat treatment further increases the stain resistance, as mentioned above.

TABLE 2
Kool-Aid Test on Sock Samples

| Example | As-dyed | 160° C., 5 min | 170° C., 5 min | 180° C., 5 min |
|---|---|---|---|---|
| 1 | 7 | 8 | 9 | 9 |
| 2 | 6-7 | 8 | 9 | 9 |
| 3 | 7-8 | 9 | 9 | 9 |
| Control | 1 | 2 | 3 | 3 |

The durability of a carpet's stain resistance after multiple cleanings (i.e. wash durability), is an important property of carpet used in high traffic areas such as hotels, restaurants, hospitals and airports since such carpets are generally cleaned very frequently. Thus, Table 3 shows Kool-Aid stain resistance test results for the wash durability of the sock samples (i.e. Examples 1-3). The sock samples were dyed at pH 6, (which is a common pH of a dye bath) for 30 minutes at the boiling temperature of the dye bath, then 0.2% by weight of fiber of Zelan® was added to the dye bath. After 10 additional minutes of boiling, the pH was adjusted to 3.3 using Auto-acid 10. The sock samples were allowed to continue boiling for another 10 minutes, and then removed, rinsed with tap water and dried. The samples were dried by heat treating at 180 degrees C for five (5) minutes in a drying oven known as the Benz oven. The Benz oven is made by Mathis Corporation of Concord, N.C. The samples were washed multiple times by mounting them onto a board and then cleaning them with a carpet cleaning steamer and cleaning solution, both available from Rug Doctor, L. P., Plano, Tex. Table 3 shows the stain resistance measured after the first, second and fourth washings. As can be seen, the stain resistance remained the same after four washings for each sample.

TABLE 3
Wash Durability

| Sample | As is | 1 × wash | 2 × wash | 4 × wash |
|---|---|---|---|---|
| Example 1 | 7 | 9 | 9 | 9 |
| Example 2 | 6-7 | 9 | 9 | 9 |
| Example 3 | 7-8 | 9 | 9 | 9 |

II. Carpet samples

Carpet samples were made from the nylon yarns described in Table 1. These samples are referred to herein as Examples 1C, 2C and 3C, respectively. The yarns were twisted, heat set, and tufted according to the following specifications:

2 ply twisted at 4.75 turns per inch

Heat set on a Superba machine at 230 degrees C for 1 minute

Pile height of 7/32 inch as tufted

Face weight of 32 ounces per square yard

Gauge of 1/10 inch

The carpet samples were dyed in a small dyer known as the Saucier Beck, made by Charles Saucier & Sons, Inc., Minneapolis, Minn. The Saucier Beck Dyer composition was:

| | | |
|---|---|---|
| Carpet fiber weight: | 220 | g |
| Wetter: | 0.44 | g |
| Monosodium phosphate: | 1.32 | g (buffer) |
| Dyes: | | |
| Tectilon Blue 4RS 200%: | 0.0132 | g |
| Tectilon Yellow 3R 200%: | 0.0132 | g |
| Tectilon Red 2B 200%: | 0.00924 | g |
| Zelan ® 25% solution: | 4.46 | g |
| Water: | 8000 | g |

Salt, acid dyestuffs and water were added to the dye bath. The dye bath was heated by steam to a boiling temperature and maintained at the boiling temperature for 20 minutes. Then 0.2% Zelan® 8236 by weight of fiber was added to the dye bath. After 10 minutes at the boiling temperature, Auto-acid 10 was added to reduce the pH to 4-4.5. The bath continued to boil for 10 minutes. Then the bath was cooled down to 150 degrees F (65.56° C.). The carpet samples were then rinsed and dried. The carpet samples were then dried at 160 degrees C for 5 minutes and then further dried twice at 127 degrees C for 2.5 minutes each time. Drying at 127 degrees C twice was meant to simulate the drying process after dyeing and applying the latex backing. The carpet samples were dyed light gray. This is how the samples for column I of Table 4 were prepared.

The carpet samples of column II, III were similarly processed in the same way as column I, however, 0.5% Zelan® rather than 0.2% Zelan® was added to the dye bath. In column II, the 0.5% Zelan® was added at the beginning of the dyeing process, i.e. the Zelane was mixed in the dye bath, then the dye was heated to boiling to dye the carpet. In column III, the Zelan® was added 30 minutes after boiling the dye bath. There is an increase in stain resistance in Example 1C for column III, however, for the most part the point at which the phenolic stain blocker is added to the dye bath does not appear to affect the stain resistance when compared to a dye bath with a similar percentage of stain blocker.

The Kool-Aid stain ratings of the samples were measured and the results are summarized in Table 4. Additionally, Example 1C carpet samples were measured for stain resistance after adding 1% Zelan® and 2% Zelan® in the manner described for column III above. For 1% and 2% Zelan® the Kool-Aid stain resistance measurement was 9+.

TABLE 4
Kool-Aid Test on Carpet Samples

| Sample | I | II | | III |
|---|---|---|---|---|
| As dyed | 0.2% Zelan ® | 0.5% Zelan ® | | 0.5% Zelan ® |
| twice | 160° C./5 min. | 127° C./2.5 min twice | | 127° C./2.5 min |
| Example 1C | 4 | 5+ | 6 | 6+ |
| Example 2C | 5 | 7 | 9 | 9 |
| Example 3C | 6 | 8+ | 9 | 9 |
| Control | 1 | 2 | 2 | 2 |

A. Addition of Detergent

It was found that trace amounts of detergent added to the dye bath increase the stain resistance of nylon carpet. Table 5 shows the change in stain resistance results caused by small amounts of detergent. The yarn example used for the results of table 5 was that of Example 1 of Table 1. The carpet samples were dyed according to the process described above for the 0.5% Zelan carpet samples of column III. Witconate is a detergent available from Witco Corporation, Houston, Tex. Softcide® is a detergent available from Stahmer Weston Scientific, Portsmouth, N.H.

The dye bath composition for 0.02% Softcide detergent was the following:

| | wt % on yarn |
|---|---|
| Monosodium phosphate: | 0.6% |
| Wetter(dioctyl sodium succinate): | 0.18% |
| Dyes (Light gray color): | 0.0162% |
| Zelan ® 30% solution: | 0.67% (or .2% active |
| | ingredient of Zelan ®) |
| Water: | 2500% |
| Auto-acid 10: | 0.03% |
| Softside ®: | 0.02% |

The value of weight percent of the active ingredient of Zelan® on the fiber can range from 0.2% to 2% (or 0.67% -6.67% load on 30% Zelan®). In the above dye bath composition, the loading of 30% Zelan® solution is 0.67% weight percent of fiber which is equivalent to 0.2% active ingredient of Zelan®. (i.e. 0.30×0.67=0.201 weight percent.)

TABLE 5
Detergent Effect on Stain Resistance

| Detergent | Detergent | |
|---|---|---|
| type | wt % on fiber | Stain rating |
| no detergent | — | 4 |
| Witconate | 0.005 | 5 |
| Witconate | 0.010 | 6 |
| Witconate | 0.020 | 6+ |
| Witconate | 0.130 | 8+ |
| Softcide | 0.001 | 3 |
| Softcide | 0.010 | 5+ |
| Softcide | 0.020 | 9+ |

B. Wash Durability

A dyed carpet sample, treated with 0.5 weight percent on fiber active ingredient Zelan® and having a stain resistance rating of 9, was pre-sprayed with cleaning solution. (The cleaning solution used was Ramsey® Hard Charger™ diluted from 11 oz. to 1 gallon in water. This cleaning solution is avaliable from Ramsey company, of Marborough, Mass. 01752.) After pre-spraying with the cleaning solution, the carpet sample was then cleaned using a hot water extraction carpet cleaning machine available from Rug Doctor, L. P., Plano, Texas. The carpet sample was then allowed to dry. After drying, the carpet was placed in a soiler drum to soil the carpet sample. The soiler drum is a 40 inch diameter rotating drum containing Zytel® resin (available from E. I. DuPont de Nemours and Company, Wilmington, Del.) pellets and soil. This is intended to simulate the soiling that occurs with human traffic. A carpet sample was mounted onto a board and placed inside the drum. Dirt was deposited on the pellets, and 250 grams of the soiled pellets were placed inside the drum. A 1-kilogram ⅜-inch ball bearing was placed into the drum. The drum was then rotated for 30 minutes. Then the sample was cleaned in the manner described above. The sample was soiled and cleaned six times each, alternately. The stain resistance of the carpet sample was then measured; it remained unchanged at 9. This sample exhibited durable stain resistance.

It is therefore, apparent that there has been provided in accordance with the present invention, treating a textile article with a phenolic oligomer stain blocker composition that is free of sulfonic and carboxylic groups during the dyeing process that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

It is claimed:

1. An improved process for dyeing a textile article containing nylon fiber comprising:
passing the textile article through a boiling dye bath containing an effective amount of a stain blocker for stain resistance, wherein the stain blocker comprises phenolic groups and is free of sulfonic groups and carboxylic groups;
rinsing the textile article after passing the textile article through the boiling dye bath; and
drying the textile article after rinsing.

2. The process of claim 1, wherein the boiling dye bath comprises between 0.2% and 2.0% by weight of fiber of the stain blocker.

3. The process of claim 2, wherein the boiling dye bath comprises between 0.2% to 0.5% by weight of fiber of the stain blocker.

4. The process of claim 1, wherein the drying is carried out at a temperature of at least 80 degrees C.

5. The process of claim 4, wherein the drying is carried out at a temperature of at least 130 degrees C for between 2 and 10 minutes.

6. The process of claim 1, comprising adding the stain blocker to a dye bath prior to boiling the dye bath.

7. The process of claim 1, comprising adding the stain blocker to the boiling dye bath.

8. The process of claim 7, wherein the stain blocker is added 30 minutes after boiling begins in the boiling dye bath.

9. The process of claim 4 or 5, further comprising:
applying a latex backing to the textile article; and
heating the textile article to at least 80 degrees C until the backing is cured.

10. The process of claim 9, wherein the heating of the textile article is to at least 130 degrees C.

11. The process of claim 9, wherein heating of the textile article is between 5 and 10 minutes.

12. The process of claims 8, further comprising heating the textile article further at a temperature of at least 125 degrees C for at least 5 minutes.

13. The process of claim 1, wherein the textile article remains in the boiling dye bath for between 30 and 45 minutes.

14. The process of claim 1, further comprising scouring the textile article to remove finish oils before passing the textile article through the boiling dye bath.

15. The process of claim 1, further comprising adjusting pH of the boiling dye bath to between 3 and 5 prior to rinsing the textile article.

16. The process of claim 1, further comprising adding 0.005% to 0.5% by weight of detergent to a dye bath prior to boiling the dye bath.

17. The process of claim 1, further comprising adding 0.005% to 0.5% by weight of detergent to the boiling dye bath prior to passing the textile article therethrough.

18. A textile article comprising nylon fiber, dyeable by acid dyes, having thereon an effective amount of stain blocker for stain resistance, wherein the stain blocker contains phenolic groups and is free of sulfonic groups and carboxylic groups.

19. A textile article of claim 18, wherein the nylon fiber comprises between 0.2% to 2.0% by weight of the fiber of a stain blocker thereon.

20. A textile article of claim 18, wherein the nylon fiber comprises between 0.2% to 0.5% by weight of fiber of the stain blocker thereon.

21. A textile article of claim 18, wherein the textile article is rated at least 8 on a Kool-Aid stain rating scale.

22. The textile article of claim 18, wherein the nylon fiber comprises a nylon homopolymer or a nylon/polyester/dimethyl 5-sulfoisophthalate copolymer.

23. The textile article of claim 18, wherein the textile article comprises a floor covering article.

24. The textile article of claim 23, wherein the floor covering article comprises a carpet.
